(19) United States
(12) Patent Application Publication
(10) Pub. No.: US 2026/0299377 A1
(43) Pub. Date: Oct. 1, 2026

(54) OPTICAL APPARATUS

(71) Applicant: CANON KABUSHIKI KAISHA, Tokyo (JP)

(72) Inventor: KANAE NAKAMORI, Kanagawa (JP)

(21) Appl. No.: 19/552,509

(22) Filed: Feb. 27, 2026

(30) Foreign Application Priority Data
Mar. 26, 2025 (JP) 2025-051818
Dec. 8, 2025 (JP) 2025-239543

(51) Int. Cl. G03B 13/36; G02B 15/14; G03B 5/00

(52) U.S. Cl. CPC G03B 13/36; G02B 15/14; G03B 5/00; G03B 2205/0046; G03B 2205/0084

(57) ABSTRACT

An optical apparatus may include three linear actuators, each of which drives a corresponding one of three optical elements, three drive units, each of which drives a corresponding one of the three linear actuators, and three position detectors, each of which detects a corresponding one of positions of the three optical elements. The three linear actuators may be arranged in different orientations. One of the three drive units and one of the three position detectors are disposed between two of the three linear actuators.

### BACKGROUND

### Field of the Technology

The present disclosure relates to an optical apparatus.

### Description of the Related Art

In order to achieve a high-speed and quiet autofocus (AF) function, optical apparatuses including a vibration wave motor as one type of linear actuator have conventionally been known. Japanese Patent Application Laid-Open No. 2020-187232 discloses an optical apparatus in which circuit components constituting a power supply are accommodated in a concave shape in a side surface of a barrel that is disposed on an inner circumference of a cam barrel.

However, in the structure disclosed in Japanese Patent Application Laid-Open No. 2020-187232, in a case where three or more linear actuators (ultrasonic motors) are arranged, the size of the optical apparatus may increase depending on the positions of a boost inductor and an optical position detection sensor.

### SUMMARY

An optical apparatus according to one aspect of the present disclosure may include three linear actuators, each of which drives a corresponding one of three optical elements, three drive units, each of which drives a corresponding one of the three linear actuators, and three position detectors, each of which detects a corresponding one of positions of the three optical elements. The three linear actuators may be arranged in different orientations. One of the three drive units and one of the three position detectors may be disposed between two of the three linear actuators.

An optical apparatus according to another aspect of the present disclosure may include a first substrate, a second substrate different from the first substrate, and a barrel that holds the first substrate and the second substrate. Each of the first substrate and the second substrate may be a flexible substrate that can move and bend. The barrel may have a wall. The first substrate may be disposed on a first surface of the wall, and the second substrate may be disposed on a second surface of the wall.

Features of the present disclosure will become apparent from the following description of embodiments with reference to the attached drawings. The following description of embodiments is described by way of example.

### BRIEF DESCRIPTION OF THE DRAWINGS

FIGS. 1A and 1B are perspective views of an imaging system according to the present embodiment.

FIG. 2 is a block diagram of the imaging system according to the present embodiment.

FIG. 3 is a sectional view of a lens apparatus according to the present embodiment.

FIG. 4 is an exploded perspective view of a vibration wave motor, a power supply circuit, and an optical position detection sensor according to the present embodiment.

FIGS. 5A and 5B are explanatory diagrams illustrating the arrangement of a boost inductor and a drive circuit of a focus vibration wave motor, and a zoom-main-unit position detection sensor, according to the present embodiment.

FIGS. 6A and 6B are explanatory diagrams illustrating the arrangement of a boost inductor and a drive circuit of a zoom-main-unit vibration wave motor, and a zoom-subunit position detection sensor, according to the present embodiment.

FIGS. 7A and 7B are explanatory diagrams illustrating the arrangement of a boost inductor and a drive circuit of a zoom-subunit vibration wave motor, and a focus-unit position detection sensor, according to the present embodiment.

FIGS. 8A and 8B are sectional views of a fixed barrel and the vibration wave motor according to the present embodiment.

FIGS. 9A and 9B are layout diagrams of the fixed barrel and circuit components for each vibration wave motor according to the present embodiment.

FIG. 10 is a schematic diagram illustrating the arrangement of the fixed barrel, vibration wave motors, boost inductors, and optical position detection sensors according to the present embodiment.

FIGS. 11A and 11B are explanatory diagrams of drive wiring according to the present embodiment.

FIG. 12 is a schematic diagram illustrating the arrangement of the fixed barrel, vibration wave motors, boost inductors, drive wiring, and optical position detection sensors according to the present embodiment.

FIG. 13 is a perspective view of an aperture unit according to the present embodiment.

FIG. 14 is an explanatory diagram of an aperture flexible printed wiring (or circuit) board (or flexible printed circuit: FPC) provided in the zoom main unit according to the present embodiment.

FIG. 15 is an explanatory diagram illustrating the arrangement of the aperture FPC and the fixed barrel according to the present embodiment.

FIGS. 16A and 16B are explanatory diagrams illustrating the arrangement of the aperture FPC and the focus FPC in a wide-angle (WIDE) state (at a WIDE end) according to the present embodiment.

FIGS. 17A and 17B are explanatory diagrams illustrating the arrangement of the aperture FPC and the focus FPC in a telephoto (TELE) state (at a telephoto end) according to the present embodiment.

FIGS. 18A and 18B are explanatory diagrams illustrating the arrangement, when viewed in an optical-axis cross section, of the aperture FPC and the focus FPC, according to the present embodiment.

FIG. 19 is an explanatory diagram illustrating movable ranges of the aperture FPC and the focus FPC according to the present embodiment.

### DESCRIPTION OF THE EMBODIMENTS

Hereinafter, embodiments of the present disclosure will be described in detail with reference to the drawings. Throughout the drawings, the same reference numerals denote the same or corresponding parts. The present embodiment will discuss an interchangeable lens as an example of an optical apparatus. However, the present disclosure is not limited to this example, and various modifications and changes may be made within the gist of the present disclosure, such as application to a lens-integrated camera.

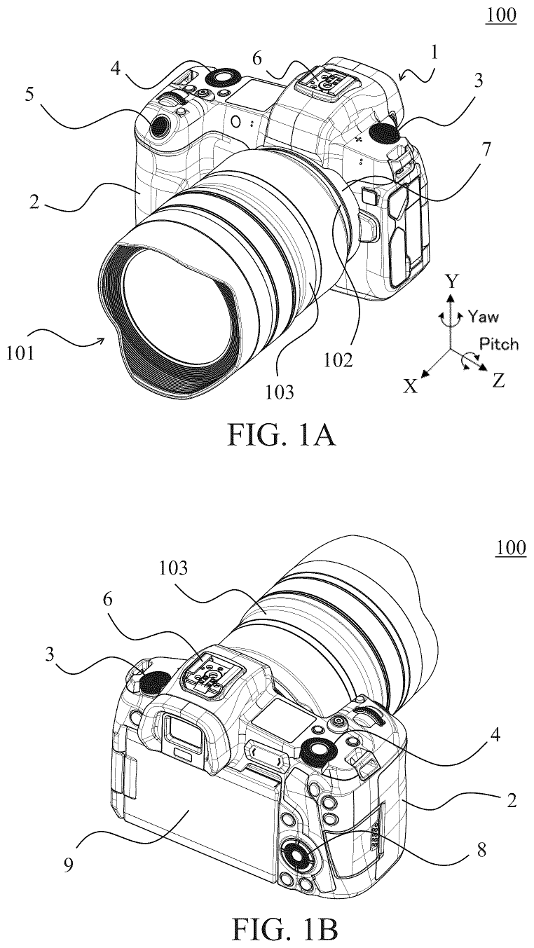

FIGS. 1A and 1B are external views of an imaging system (camera system) 100 according to the present embodiment. FIG. 1A is a perspective view viewed from a front side, and FIG. 1B is a perspective view viewed from a rear side. The imaging system 100 consists of a camera body (image pickup apparatus) 1 and a lens apparatus (interchangeable lens, optical apparatus) 101 that is detachably attached to the camera body 1. The present embodiment is not limited to this example, and is also applicable to an image pickup apparatus in which the camera body and the lens apparatus are integrated.

As illustrated in FIG. 1A, an optical axis direction in which an optical axis of an imaging optical system accommodated in the lens apparatus 101 extends is defined as an X-axis direction. Directions orthogonal to the X-axis direction are defined as a Z-axis direction (horizontal direction) and a Y-axis direction (vertical direction). Hereinafter, the Z-axis direction and the Y-axis direction are also collectively referred to as a Z/Y-axis direction. A rotation direction about the Z-axis is defined as a pitch direction, and a rotation direction about the Y-axis is defined as a yaw direction. The pitch direction and the yaw direction are rotation directions about two axes, the Z-axis and the Y-axis, which are orthogonal to each other.

A grip portion 2 for a user to hold the camera body 1 by hand is provided on a portion of the camera body 1 that is on a left side when viewed from the front or object side (a right side when viewed from the rear). A power operation unit 3 is disposed on an upper surface of the camera body 1. When the user operates the power operation unit 3 to a power-on position while the camera body 1 is in a power-off state, the camera body 1 enters a power-on state and imaging (shooting or capturing an image) becomes available. When the user operates the power operation unit 3 to a power-off position while the camera body 1 is in a power-on state, the camera body 1 enters a power-off state.

A mode dial 4, a release button 5, and an accessory shoe 6 are provided on the upper surface of the camera body 1. By rotating the mode dial 4, the user can switch an imaging mode. The imaging mode includes a manual still image capturing mode in which the user can arbitrarily set an imaging mode such as a shutter speed and an aperture value (F-number), an automatic still image capturing mode for automatically obtaining a proper exposure amount, and a moving image capturing mode for capturing a moving image. By half-pressing the release button 5, the user can instruct an imaging preparation operation such as autofocus (AF) and auto-exposure (AE) control, and by fully pressing the release button 5, the user can instruct imaging. An accessory such as an external flash or an external viewfinder (EVF), not illustrated, is detachably attached to the accessory shoe 6. An image sensor that photoelectrically converts an object image formed by the imaging optical system in the lens apparatus 101 is provided inside the camera body 1.

The lens apparatus 101 is mechanically and electrically connected to a camera mount 7 provided on the camera body 1 via a lens mount 102. As described above, the lens apparatus 101 accommodates the imaging optical system that forms an object image by imaging light from an object. A zoom operation ring (zoom operation member) 103 that is rotatable about the optical axis by user operation is provided on an outer circumference of the lens apparatus 101. A knurled shape is formed on an outer circumference portion of the zoom operation ring 103 so that a user's hand does not slip during operation. When the zoom operation ring 103 is rotated by the user, the zoom unit constituting the imaging optical system moves the optical position in accordance with the operation of the zoom operation ring 103. Details of the zoom operation will be described later. By operating the zoom operation ring, the user can perform imaging at a desired angle of view.

As illustrated in FIG. 1B, a rear operation unit 8 and a display unit 9 are provided on a rear surface of the camera body 1. The rear operation unit 8 includes a plurality of buttons and dials to which various functions are assigned. When the camera body 1 is in a power-on state and a still or moving imaging mode is set, the display unit 9 displays a through-image of the object image captured by the image sensor. The display unit 9 also displays an imaging parameter indicating an imaging condition such as a shutter speed and an aperture value. The user can change a set value of the imaging parameter by operating the rear operation unit 8 while viewing the display. The rear operation unit 8 includes a playback button for instructing playback of recorded captured images. When the user operates the playback button, the captured image is played back and displayed on the display unit 9.

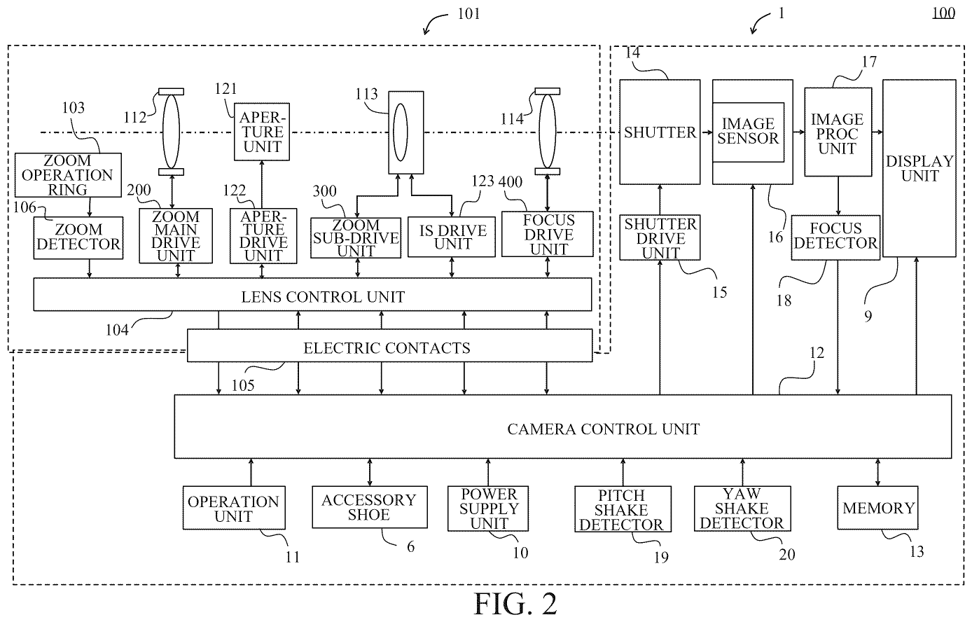

FIG. 2 is a block diagram illustrating electrical and optical configurations of the imaging system 100 consisting of the lens apparatus 101 and the camera body 1. The camera body 1 has a power supply unit 10 that supplies power to the camera body 1 and the lens apparatus 101, and an operation unit 11 including the power operation unit 3, the mode dial 4, the release button 5, the rear operation unit 8, and a touch panel function of the display unit 9. Control of the entire system including the camera body 1 and the lens apparatus 101 is performed by cooperation between a camera control unit 12 provided in the camera body 1 and a lens control unit 104 provided in the lens apparatus 101. The camera control unit 12 reads and executes a computer program stored in a memory 13. At that time, the camera control unit 12 communicates a variety of control signals and data with the lens control unit 104 via communication terminals of electrical contacts 105 provided on the lens mount 102. The electrical contacts 105 include power terminals that supply power from the power supply unit 10 to the lens apparatus 101.

The lens apparatus 101 includes a zoom operation ring 103 for changing an angle of view of an imaging optical system, and a zoom detector 106 that detects an angle of the zoom operation ring 103. The zoom detector 106 detects, as an absolute value, an angle (position) of the zoom operation ring 103 operable by a user, and is configured using, for example, a resistive linear potentiometer. Angle-of-view information detected by the zoom detector 106 is transmitted to a lens control unit 104 and reflected in various types of control performed by the camera control unit 12 described above. On the other hand, part of various types of information is stored together with captured images in a memory 13 or in a recording medium (not illustrated).

The imaging optical system in the lens apparatus 101 includes a zoom main unit (zoom lens, first optical member) 112 that moves in an optical axis direction to change an angle of view, and a zoom subunit (second optical member) 113 that has a role of a lens image-stabilizing (IS) unit including a shift lens serving as an image stabilizing element for reducing image blur. The zoom subunit 113 performs an image stabilizing operation by moving (shifting) the shift lens in Z/Y-axis directions orthogonal to the optical axis to reduce image blur. The imaging optical system further includes an aperture unit 121 that performs a light-amount adjusting operation, and a focus unit (third optical member) 114 including a focus lens that moves in the optical axis direction to perform focusing.

The lens apparatus 101 further includes a zoom main drive unit 200 that drives the zoom main unit 112 to move in the optical axis direction, and a zoom sub-drive unit 300 that drives the zoom subunit 113 to move in the optical axis direction. The lens apparatus 101 further includes an image-stabilization drive unit 123 that drives the lens image-stabilizing unit to shift the shift lens, an aperture drive unit 122 that drives the aperture unit 121, and a focus drive unit 400 that drives the focus unit 114 to move the focus lens.

As described later, the zoom main drive unit 200 includes a vibration wave motor (first linear actuator) 201. The zoom sub-drive unit 300 includes a vibration wave motor (second linear actuator) 301. The focus drive unit 400 includes a vibration wave motor (third linear actuator) 401.

The camera body 1 includes a shutter unit 14, a shutter drive unit 15, an image sensor 16, an image processing unit 17, and the camera control unit 12 described above. The shutter unit 14 controls the amount of light that is condensed by the imaging optical system in the lens apparatus 101 and exposed on the image sensor 16. The image sensor 16 photoelectrically converts an object image formed by the imaging optical system and outputs an imaging signal. The image processing unit 17 performs a variety of image processing operations on the imaging signal and then generates an image signal. The display unit 9 displays the image signal (through-image or live-view image) output from the image processing unit 17, displays an imaging parameter as described above, or plays back and displays a captured image recorded in the memory 13 or an unillustrated recording medium.

The camera control unit 12 controls driving of the aperture unit 121 and the shutter unit 14 via a motor movable unit (aperture drive unit) 402 and the shutter drive unit 15 in accordance with set values of the aperture value and shutter speed received from the operation unit 11. The camera control unit 12 controls driving of the focus unit 114 in accordance with an imaging preparation operation (half-press operation) of the release button 5 of the operation unit 11. For example, in a case where an autofocus operation is instructed, a focus detector 18 determines a focus state of an object image formed on the image sensor 16 based on an image signal generated by the image processing unit 17, generates a focus signal, and transmits the focus signal to the camera control unit 12. At the same time, the focus drive unit 400 detects a current position of the focus unit 114 and transmits the signal to the camera control unit 12 via the lens control unit 104. The camera control unit 12 compares the focus state of the object image with the current position of the focus unit 114, calculates a focus drive amount from a shift amount, and transmits the focus drive amount to the lens control unit 104. The lens control unit 104 then controls driving of the focus unit 114 via the focus drive unit 400 to a target position, thereby correcting a focus shift of the object image.

In a case where an auto-exposure (AE) control operation is instructed, the camera control unit 12 receives a luminance signal generated by the image processing unit 17 and performs photometric calculation (or light metering calculation). Based on a result of the photometric calculation, the camera control unit 12 controls driving of the aperture unit 121 according to an imaging instruction operation (full-press operation) of the operation unit 11 (the release button 5). The camera control unit 12 also controls driving of the shutter unit 14 via the shutter drive unit 15 and performs exposure processing by the image sensor 16.

The camera body 1 includes a pitch shake detector 19 and a yaw shake detector 20 as shake detectors capable of detecting image blur such as camera shake caused by a user. The pitch shake detector 19 and the yaw shake detector 20 detect image blur in a pitch direction (a rotation direction about the Z-axis) and a yaw direction (a rotation direction about the Y-axis) using an angular velocity sensor (vibration gyro) or an angular acceleration sensor, and output a shake signal. The camera control unit 12 calculates a shift position of a lens image-stabilizing unit (zoom subunit 113) in the Y-axis direction using the shake signal from the pitch shake detector 19. Similarly, the camera control unit 12 calculates a shift position of the lens image-stabilizing unit (zoom subunit 113) in the Z-axis direction using the shake signal from the yaw shake detector 20. Then, the camera control unit 12 drives and controls the lens image-stabilizing unit (zoom subunit 113) to a target position according to the calculated shift positions in the pitch/yaw directions, and performs an image stabilizing operation to reduce image blur during exposure or through-image display.

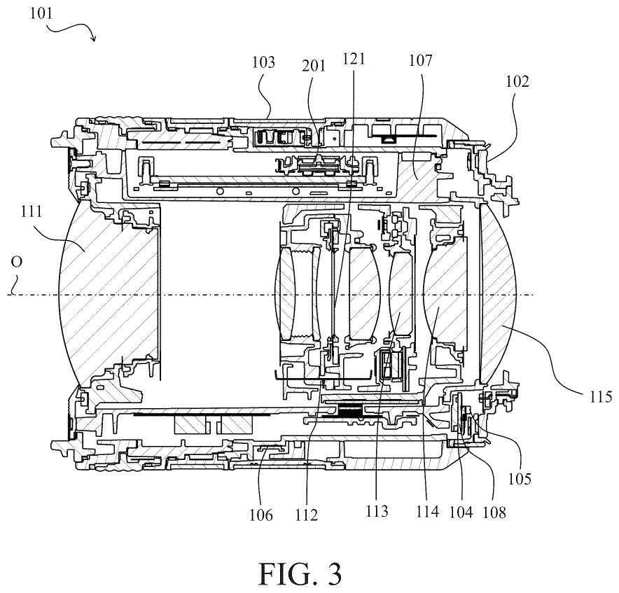

Next, with reference to FIG. 3, a positional relationship among components in the lens apparatus 101 will be described. FIG. 3 is a sectional view on an XY plane including the optical axis of the lens apparatus 101. A centerline O illustrated in FIG. 3 approximately coincides with the optical axis determined by the imaging optical system, and therefore the centerline O is hereinafter regarded as being synonymous with the optical axis.

As illustrated in FIG. 3, the present embodiment employs, as an example of the imaging optical system, a five-unit configuration including three movable units and two fixed units. The three movable units include the zoom main unit 112, the zoom subunit 113, and the focus unit 114. The zoom main unit 112 functions as a first movable unit, the zoom subunit 113 functions as a second movable unit, and the focus unit 114 functions as a third movable unit. The aperture unit 121 is included in the zoom main unit 112. As actuators constituting drive units of the respective movable units, linear-type vibration wave motors, which are a type of ultrasonic motor (referred to as “vibration wave motors” hereinafter), are mounted. As one example, the vibration wave motor 201 moves the zoom main unit 112 in an optical axis direction. Details of the vibration wave motors will be described later.

The two fixed units include a first lens unit 111 and a fifth lens unit 115, which are fastened to a fixed barrel 107 by screws. The fixed barrel 107 is fixed to a lens mount 102, and is a fixed member that holds a main circuit board 108 mounted with a lens control unit 104, and also holds drive units of the respective zoom units. Details thereof will be described later. The present disclosure does not limit a configuration of the lens units. For example, the first lens unit 111 is not limited to the fixed configuration, and may be movable.

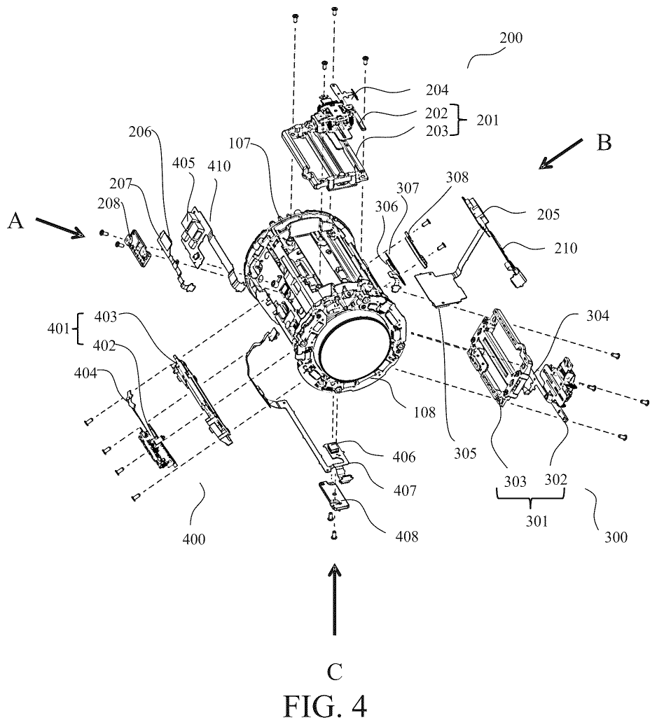

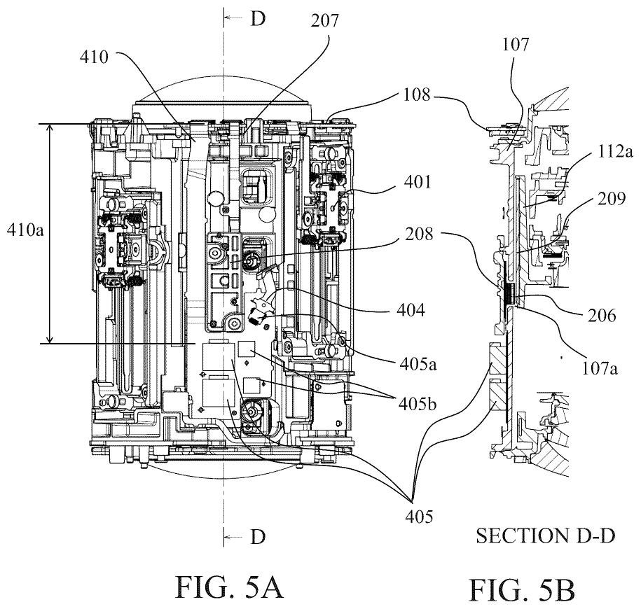

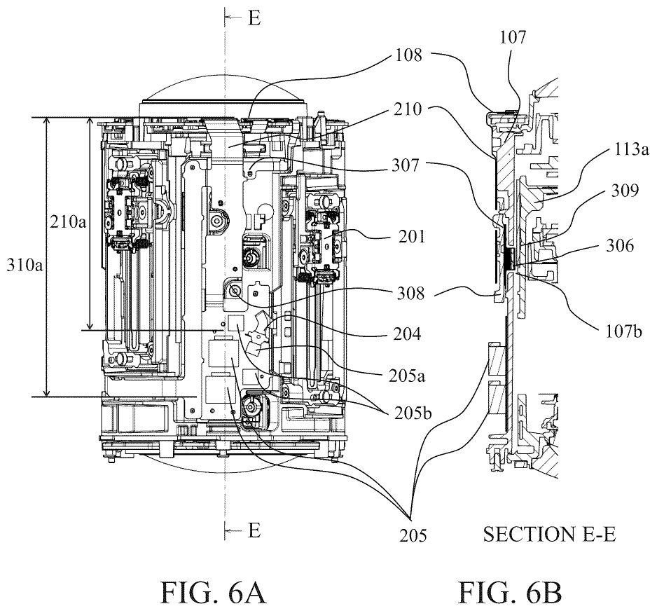

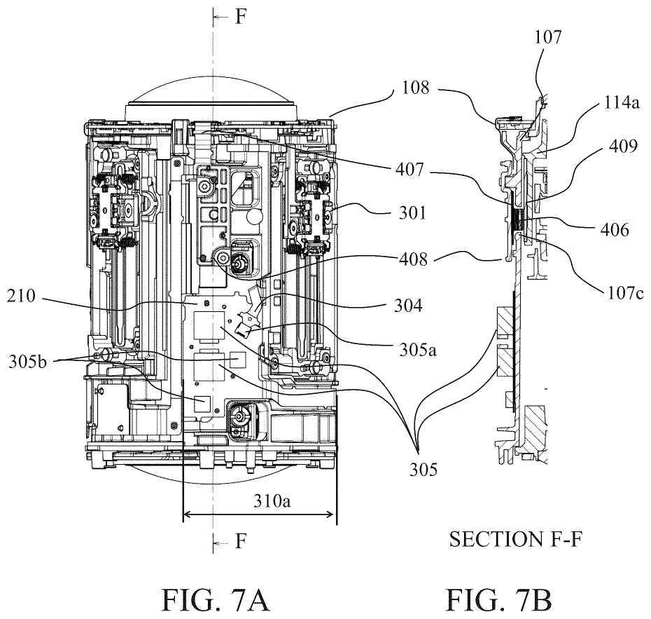

Next, characteristic components of the present disclosure will be described in detail with reference to FIGS. 4, 5A, 5B, 6A, 6B, 7A, 7B, 8A, 8B, 9A, 9B, 10, 11A, 11B, and 12. FIG. 4 is an exploded perspective view illustrating the fixed barrel 107, vibration wave motors of the respective zoom units, power supply circuits (power supply units) of the vibration wave motors, and optical position detection sensors that detect respective drive positions, when viewed obliquely from the rear. FIG. 5A is a view of the fixed barrel 107 when viewed from a direction of arrow A in FIG. 4. FIG. 5B is a sectional view illustrating an area around an optical position detection sensor for the zoom main unit 112, and corresponds to a cross section taken along line D-D in FIG. 5A. FIG. 6A is a view of the fixed barrel 107 when viewed from a direction of arrow B in FIG. 4. FIG. 6B is a sectional view illustrating an area around an optical position detection sensor for the zoom subunit 113, and corresponds to a cross section taken along line E-E in FIG. 6A. FIG. 7A is a view of the fixed barrel 107 when viewed from a direction of arrow C in FIG. 4. FIG. 7B is a sectional view illustrating an area around an optical position detection sensor for the focus unit 114, and corresponds to a cross section taken along line F-F in FIG. 7A.

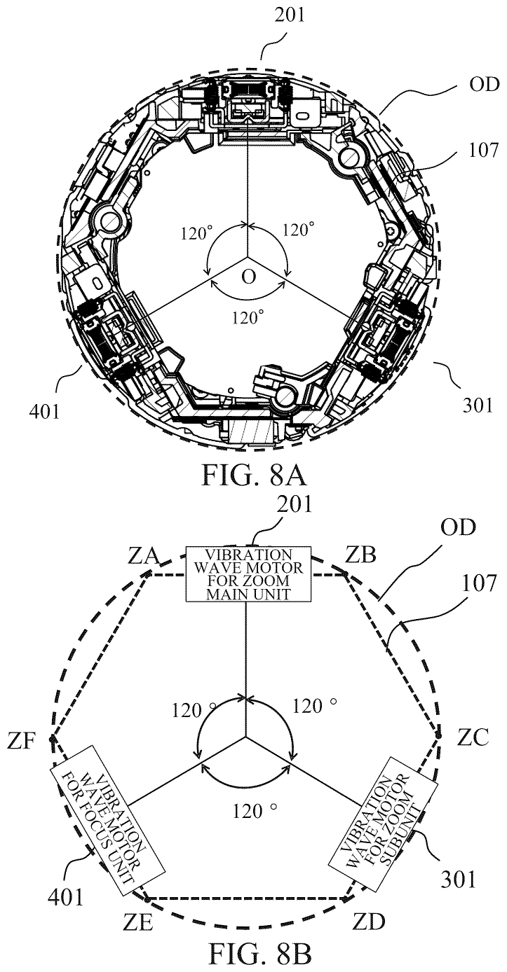

FIGS. 8A and 8B are views of a cross section orthogonal to the optical axis when viewed from an imaging surface side. FIG. 8A illustrates a sectional view illustrating a positional relationship among the vibration wave motors of the respective zoom units. FIG. 8B illustrates a schematic diagram illustrating positional relationships between the fixed barrel 107 and the vibration wave motors of the respective zoom units. As illustrated in FIGS. 8A and 8B, when viewed in a cross section orthogonal to the optical axis, the fixed barrel 107 has an approximately hexagonal shape having vertices ZA to ZF. Vibration wave motors 201, 301, and 401 are arranged on a plane orthogonal to the optical axis at intervals of approximately 120 degrees (120°) around the optical axis, and are fixed by screws.

As illustrated in FIG. 8B, an outermost diameter OD is represented by a dashed line connecting, by imaginary lines, outer diameters of the vibration wave motors 201, 301, and 401 and the vertices ZA to ZF of the fixed barrel 107. The outermost diameter OD determines a diameter of the lens apparatus 101. Therefore, reducing the outermost diameter OD can reduce a radial size of the lens apparatus 101.

As illustrated in FIG. 4, the vibration wave motors 201, 301, and 401 have their major axes in the optical axis direction, and move the zoom main unit 112, the zoom subunit 113, and the focus unit 114 in the optical axis direction via unillustrated coupling members in accordance with instructions from the lens control unit 104. Each of the vibration wave motors 201, 301, and 401 includes a corresponding one of motor movable units 202, 302, 402 having a vibrator, and a corresponding one of motor fixed portions 203, 303, 403 having a friction member. The vibrator includes a vibration plate having a friction contact portion, and a piezoelectric element fixed to a rear surface of the vibration plate by an adhesive or the like. The vibration plate is pressed into contact with the friction member at the friction contact portion. Flexible printed wiring boards 210 and 410 have circuit components mounted thereon for operating the piezoelectric elements.

More specifically, as illustrated in FIGS. 5A, 5B, 6A, 6B, 7A, and 7B, drive FPCs 204, 304, and 404 electrically connected to the piezoelectric elements are connected to the FPCs 210 and 410 via drive connectors 205a, 305a, and 405a. Thereby, the drive FPCs 204, 304, and 404 can be electrically connected to the FPCs 210 and 410 and circuit components on the main circuit board 108.

When two-phase AC voltages are applied to the piezoelectric elements as drive signals, vibrations at ultrasonic frequencies are excited. As a result, resonance occurs in the vibrator, the vibrator is deformed, and elliptical motion is generated at the friction contact portion. By changing frequencies or phases of the two-phase AC voltages applied to the piezoelectric elements, a rotation direction and an ellipticity of the elliptical motion change. Thus, the lens control unit 104 can control a traveling wave generated in the vibrator, and thereby control moving of the zoom main unit 112, the zoom subunit 113, and the focus unit 114 to target positions. The vibration wave motors 201, 301, and 401 generate drive pulses at relatively high frequencies, and switching of circuits is performed by these drive pulses.

Next, boost inductors 205, 305, and 405 constituting power supply units of the vibration wave motors 201, 301, and 401 will be described. As illustrated in FIGS. 5A, 5B, 6A, 6B, 7A, and 7B, a resonance circuit composed of the boost inductors 205, 305, and 405 and inductors 205b, 305b, and 405b enables output of voltages higher than a voltage supplied to the lens control unit 104. When power is supplied via the FPCs 210 and 410, the boost inductors 205, 305, and 405 generate magnetic fluxes in winding axis directions of coils contained therein.

In the present embodiment, as one example, magnetic flux is generated in a thickness direction of the boost inductors 205, 305, and 405. When magnetic flux is generated during a process in which the image sensor 16 generates and outputs an imaging signal, fluctuations thereof may be superimposed on the imaging signal as magnetic noise, thereby degrading image quality. More specifically, when magnetic noise reaches the image sensor 16, a magnetic field that changes the signal line of pixel charge information from which an image signal is extracted at a high frequency penetrates the image sensor. Thereby, magnetism can be generated in the signal line due to electromagnetic induction, and as a result, noise is generated in the signal line for pixel charge information.

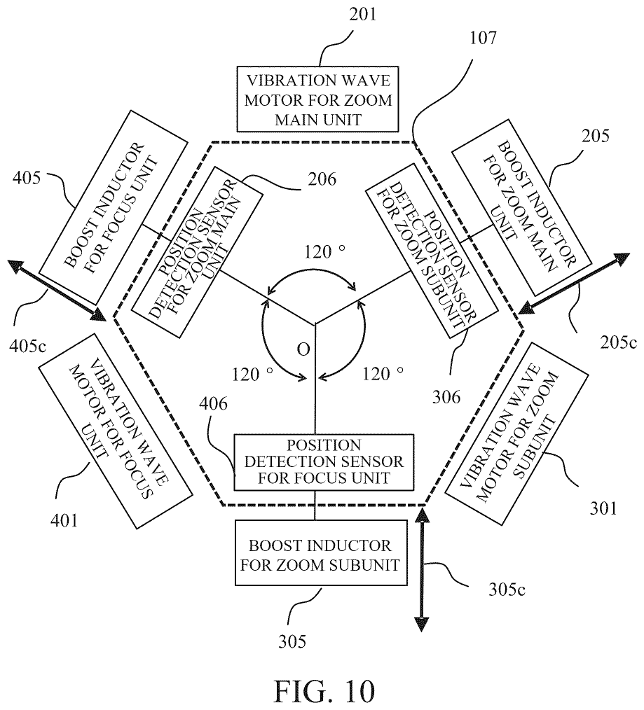

Accordingly, the present embodiment adopts a configuration in which generated magnetic flux does not intersect the imaging surface. More specifically, magnetic fluxes generated by the boost inductors 205, 305, and 405 are directed in directions of arrows 205c, 305c, and 405c illustrated in FIG. 10, respectively. Thus, the boost inductors 205, 305, and 405 are arranged such that the directions of arrows 205c, 305c, and 405c are oriented toward the optical axis. The boost inductors 205, 305, and 405 are arranged in a plane orthogonal to the optical axis at intervals of approximately 120° around the optical axis, and are arranged between the vibration wave motors 201 and 301, between the vibration wave motors 301 and 401, and between the vibration wave motors 401 and 201, respectively. More specifically, in the fixed barrel 107 having an approximately hexagonal shape on the cross section orthogonal to the optical axis, the boost inductors 205, 305, and 405 are arranged on surfaces different from surfaces on which the vibration wave motors 201, 301, and 401 are arranged. At this time, as illustrated in FIGS. 5A, 5B, 6A, 6B, 7A, and 7B, the boost inductors 205, 305, and 405 and the inductors 205b, 305b, and 405b are arranged so as to face outward in a circumferential direction.

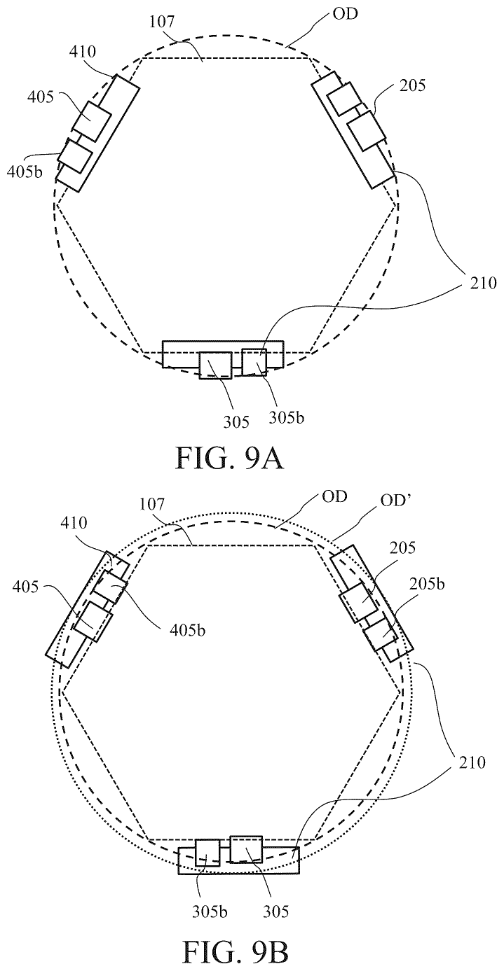

FIGS. 9A and 9B are schematic diagrams for explaining arrangements of circuit components of the fixed barrel 107 and the respective vibration wave motors, that is, the boost inductors 205, 305, and 405, and the inductors 205b, 305b, and 405b. FIG. 9A illustrates a case in which the circuit components are arranged to face an outer circumferential direction. FIG. 9B illustrates a case in which the circuit components are arranged to face an inner circumferential direction.

As illustrated in FIG. 9A, the FPCs 210 and 410 are arranged on the fixed barrel 107 such that the boost inductors 205, 305, and 405 and the inductors 205b, 305b, and 405b face the outer circumferential direction. In this case, each circuit component and each FPC are accommodated within an outermost diameter OD. On the other hand, as illustrated in FIG. 9B, the FPCs 210 and 410 are arranged on the fixed barrel 107 such that the boost inductors 205, 305, and 405 and the inductors 205b, 305b, and 405b face the inner circumferential direction. In this case, each circuit component and each FPC are accommodated within an outermost diameter OD′. The relationship between the outermost diameters OD and OD′ is OD<OD′. In general, since an FPC includes wiring for mounted circuit components, an area may be larger than the projected area of the mounted circuit components. Therefore, as illustrated in FIG. 9A, by placing the circuit components of each vibration wave motor so as to face the outer circumferential direction, the outermost diameter OD can be reduced, thereby facilitating a reduction in the radial size of the lens apparatus 101.

As described above, from a viewpoint of magnetic noise, the boost inductors 205, 305, and 405 and the inductors 205b, 305b, and 405b may be located farther from the imaging surface. Therefore, in the present embodiment, as illustrated in FIGS. 5A, 5B, 6A, 6B, 7A, and 7B, the boost inductors 205, 305, and 405 are arranged on an object side in an optical axis direction within a range that does not affect an overall lens length.

Next, optical position detection sensors 206, 306, and 406 will be described. As illustrated in FIGS. 4, 5A, 5B, 6A, 6B, 7A, and 7B, the optical position detection sensors 206, 306, and 406 are mounted on sensor FCPs 207, 307, and 407, respectively, and are electrically connectable to circuit components on the main circuit board 108. The sensor FCPs 207, 307, and 407 are attached to sensor holders 208, 308, and 408 with double-sided tape, and the sensor holders 208, 308, and 408 are fixed to the fixed barrel 107 with screws.

As illustrated in FIGS. 5A, 5B, 6A, 6B, 7A, and 7B, sensor scales 209, 309, and 409 are adhesively fixed to lens holding frames 112a, 113a, and 114a of a zoom main unit 112, a zoom subunit 113, and a focus unit 114, respectively. At this time, holes 107a, 107b, and 107c for the optical position detection sensors are provided in the fixed barrel 107 such that the optical position detection sensors 206, 306, and 406 are arranged to face the sensor scales 209, 309, and 409. On surfaces of the sensor scales 209, 309, and 409, reflective patterns for detecting positions of the respective units are provided. The lens control unit 104 can detect absolute positions of the zoom main unit 112, the zoom subunit 113, and the focus unit 114 relative to the fixed barrel 107 by using the optical position detection sensors 206, 306, and 406, each including a light emitter and a light receiver.

FIG. 10 is a schematic diagram for explaining a positional relationship among the fixed barrel 107, power supply circuits (power supply units) of the respective vibration wave motors, and the optical position detection sensors for detecting respective drive positions. As illustrated in FIG. 10, the optical position detection sensors 206, 306, and 406 are arranged at intervals of approximately 120° around the optical axis within a plane orthogonal to the optical axis. Among six surfaces of the fixed barrel 107 extending in the optical axis direction, the optical position detection sensors 206, 306, and 406 are arranged on surfaces different from surfaces on which the vibration wave motors 201, 301, and 401 are arranged. That is, the boost inductors 205, 305, and 405 and the optical position detection sensors 306, 406, and 206 are arranged so as to be parallel to predetermined surfaces of the fixed barrel 107, respectively. However, the number of surfaces of the fixed barrel 107 extending in the optical axis direction is not limited to six, and the fixed barrel 107 may have seven or more surfaces. For example, the boost inductors 205, 305, and 405 and the optical position detection sensors 306, 406, and 206 may be arranged on different surfaces, and the fixed barrel 107 may have, for example, nine surfaces.

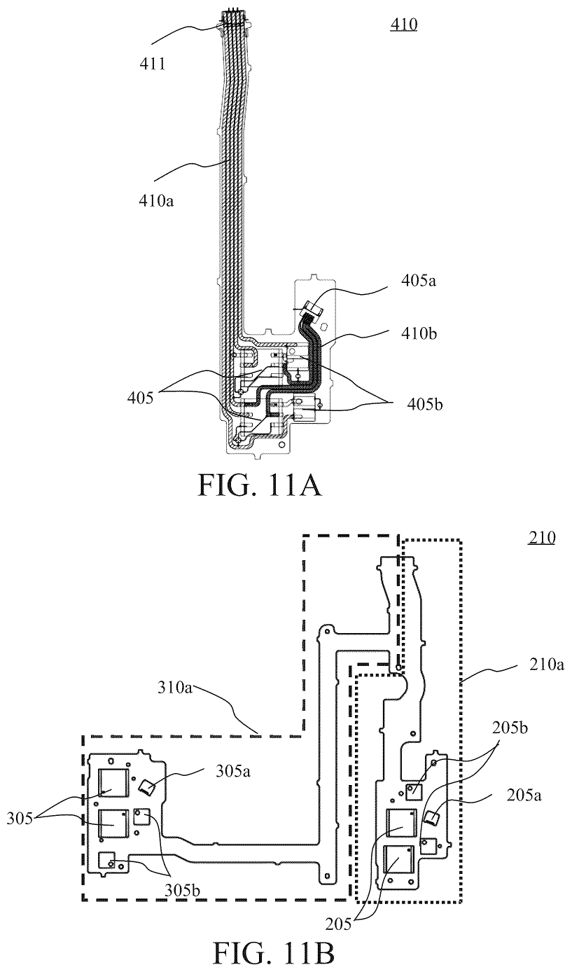

Next, with reference to FIGS. 11A and 11B, wiring of the zoom FPC 210 and the focus FPC 410 will be described. FIG. 11A is an explanatory diagram of a wiring pattern of a conductor layer of the focus FPC 410 illustrated in FIG. 5A. FIG. 11B is an explanatory diagram of ranges of drive wiring of the zoom FPC 210 illustrated in FIGS. 6A and 7A.

As illustrated in FIG. 11A, the focus FPC 410 mainly includes two wirings in order to transmit drive signals for driving the vibration wave motor 401. A first wiring 410a is a wiring pattern from a board connector 411 to the boost inductor 405. The first wiring 410a transmits a drive signal from the main circuit board 108 having the lens control unit 104 to circuit components including the boost inductor 405 and the inductor 405b. A second wiring 410b is a wiring pattern from the boost inductor 405 to the drive connector 405a. The second wiring 410b outputs a voltage higher than a voltage supplied from the main circuit board 108 by a resonance circuit of the boost inductor 405 and the inductor 405b, and transmits a drive signal to the vibration wave motor 401.

In general, wiring for the drive signal is likely to affect adjacent wiring with noise, and therefore a distance between wirings may be increased in order to reduce noise influence on adjacent wiring. Both the first wiring 410a and the second wiring 410b transmit the drive signals, but the second wiring 410b has a higher voltage due to the boost inductor 405 described above. Thus, adjacent wiring is more susceptible to noise influence. In the present embodiment, noise influence on adjacent wiring is reduced by reducing a length of the second wiring 410b.

As illustrated in FIG. 11B, the zoom FPC 210, similarly to the focus FPC 410, has wirings 210a and 310a for transmitting signals (drive signals) for driving the vibration wave motors 201 and 301. Since a configuration of the wiring is similar to that of the focus FPC 410, a description thereof will be omitted.

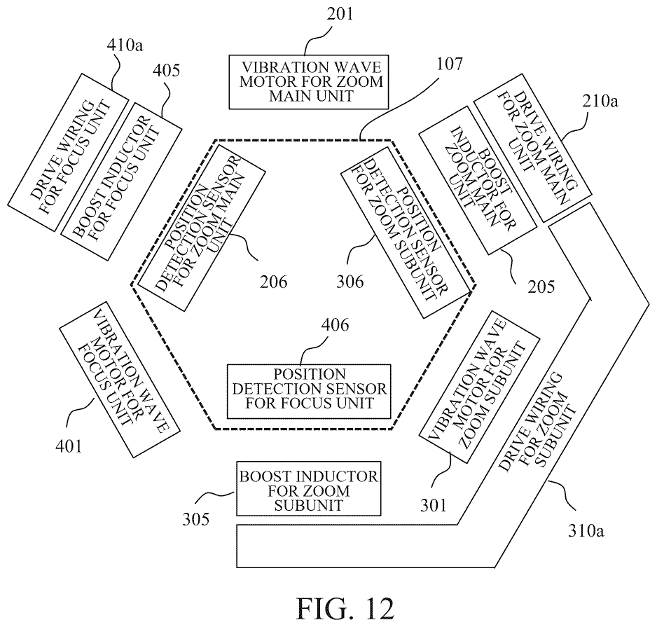

FIG. 12 is a schematic diagram for explaining positional relationships among the fixed barrel 107, vibration wave motors of the respective zoom units, power supply circuits and drive wiring of the respective vibration wave motors, and optical position detection sensors for detecting respective drive positions. As illustrated in FIG. 12, among six surfaces of the fixed barrel 107 extending in the optical axis direction, the optical position detection sensors 206, 306, and 406 are arranged so as to be parallel to predetermined surfaces on which wirings 410a, 210a, and 310a are arranged. The optical position detection sensor 206 is also arranged so as to be parallel to the wiring 310a. As described above, this is because the wirings 210a and 310a are bundled into the zoom FPC 210 in order to reduce the number of components.

The arrangements of the vibration wave motors, the boost inductors, the optical position detection sensors, and the drive-signal wiring will be described again. Among six surfaces of the fixed barrel 107 extending in the optical axis direction, the boost inductor 205, the optical position detection sensor 306, and the wiring 210a are arranged so as to be parallel to the predetermined surfaces of the fixed barrel 107, and are arranged between the vibration wave motors 201 and 301. Similarly, among six surfaces of the fixed barrel 107 extending in the optical axis direction, the boost inductors 305 and 405, the optical position detection sensors 406 and 206, and the wirings 310a and 410a are arranged so as to be parallel to the predetermined surfaces of the fixed barrel 107. Further, they are arranged between the vibration wave motors 301 and 401, and between the vibration wave motors 401 and 201, respectively. Placing the components in this manner can reduce the outermost diameter OD described with reference to FIGS. 9A and 9B, thereby reducing the radial size of the lens apparatus 101.

As illustrated in FIGS. 6A, 6B, and 12, the optical position detection sensor 306 is disposed so as to overlap the wiring 210a. The sensor holder 308 is interposed between the zoom FPC 210 and the sensor FPC 307, and they extend in parallel while being spaced apart from each other. This can avoid crosstalk influence on the sensor FPC 307 caused by the drive signal wiring 210a while achieving size reduction.

As illustrated in FIGS. 5a, 5b, 6a, 6b, 7a, and 7b, the boost inductors 205, 305, and 405 and the inductors 205b, 305b, and 405b are arranged on the object side as much as possible in the optical axis direction from the viewpoint of magnetic noise described above. Therefore, the optical position detection sensors 306, 406, and 206 are arranged on an imaging-surface side in the optical axis direction. However, in a case where a diameter of the lens apparatus 101 is large, the boost inductors 205, 305, and 405 and the inductors 205b, 305b, and 405b may be arranged side by side in the circumference direction with the optical position detection sensors 306, 406, and 206.

In the present embodiment, the sensor FPCs 207, 307, and 407 are arranged so as not to come into contact with the zoom FPC 210 and the focus FPC 410. This can reduce crosstalk influence.

As described above, in the present embodiment, the optical apparatus (lens apparatus 101) has three linear actuators (vibration wave motors 201, 301, and 401), three drive units, and three position detectors (optical position detection sensors 206, 306, and 406). The three linear actuators respectively drive three optical members (a zoom main unit 112, a zoom subunit 113, and a focus unit 114). The three drive units respectively drive the three linear actuators. The three position detectors respectively detect positions of the three optical members. The three linear actuators are arranged in mutually different orientations. Between two of the three linear actuators, one of the three drive units and one of the three position detectors are disposed.

The three drive units may include wiring 210a, 310a, and 410a for drive signals of the three linear actuators, respectively. The three drive units may include three power supply units of the three linear actuators, respectively. The three power supply units may include boost inductors 205, 305, and 405, respectively. The boost inductors may be arranged on surfaces of boards (FPCs 210 and 410) on sides farther from the optical axis. One of the three power supply units may be disposed on the object side of one of the three position detectors. Each of the three power supply units and each of the three position detectors may be provided on different boards. One of the three drive units may be disposed side by side with one of the three position detectors in the optical axis direction.

The three linear actuators may be arranged at intervals of 120° around the optical axis in a plane orthogonal to the optical axis, and the drive units and the position detectors may be arranged at intervals of 120° around the optical axis in a plane orthogonal to the optical axis. The three linear actuators, the three drive units, and the three position detectors may be arranged circumferentially around the optical axis in a plane orthogonal to the optical axis. The three linear actuators, the three drive units, and the three position detectors may be arranged such that a hexagon is formed by three mounting surfaces of the three linear actuators and three mounting surfaces of the three drive units and the three position detectors. Each of the three linear actuators may be a vibration wave motor or a voice coil motor.

In the present embodiment, each of the number of sets of the linear actuators, the drive units, and the position detectors is not limited to three, and four or more sets may be provided. For example, when the number of these sets is four, five, or six, the four, five, or six linear actuators may be arranged at intervals of 90 degrees, 72 degrees, or 60 degrees, respectively, around the optical axis.

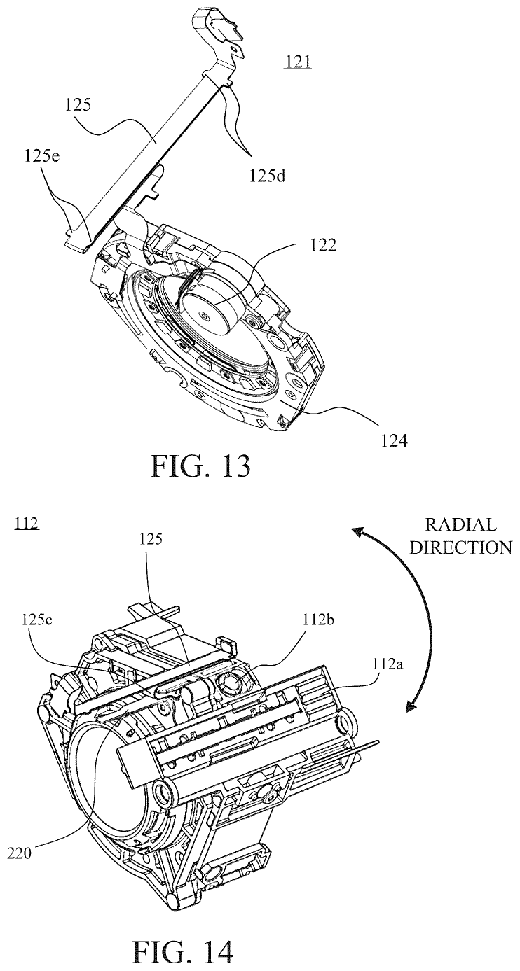

FIG. 13 is a perspective view of the aperture unit 121. The aperture unit 121 has an actuator (aperture drive unit 122) that drives aperture blades (not illustrated), a body 124 in which the aperture blades (not illustrated) are accommodated, and an aperture FPC (second board) 125 electrically connected to the actuator. The aperture FPC 125 has drive wiring and is connected to the main circuit board 108 (not illustrated). The aperture FPC 125 has position restricting portions 125d and 125e. Details of the position restricting portions 125d and 125e will be described later.

FIG. 14 is a perspective view of the aperture FPC 125 incorporated in the zoom main unit 112. The aperture FPC 125 has a movable unit 125c that is movable in the optical axis direction on a holding plate 220 in accordance with movement of the lens holding frame 112a of the zoom main unit 112.

The holding plate 220 is configured such that the movable unit 125c is movable while maintaining a U-shape without interfering with surrounding components. In the present embodiment, the holding plate 220 is a separate metal component, but it may be integrated with the lens holding frame 112a. Adjustment rollers (adjustment members) 112b for optical adjustment are arranged on the lens holding frame 112 a of the zoom main unit 112 at intervals of approximately 120° around the optical axis. At this time, the aperture FPC 125 and the adjustment rollers 112b are arranged so as to overlap each other in a radial direction. The adjustment rollers 112b are adjusted from outside the fixed barrel 107 after the zoom main unit 112 is incorporated into the fixed barrel 107. Therefore, the aperture FPC 125 is disposed so as not to overlap the adjustment rollers 112b on rotation center axes of the adjustment rollers 112b. That is, the adjustment rollers 112b are not covered by the aperture FPC 125.

In a case where the aperture FPC 125 and the adjustment rollers 112b are arranged side by side in the same optical axis direction, the unit length of the zoom main unit 112 increases. Therefore, arranging them so as to overlap each other in the radial direction as in the present embodiment can reduce the unit length of the zoom main unit 112 without obstructing the adjustment rollers 112b, thereby shortening an overall lens length.

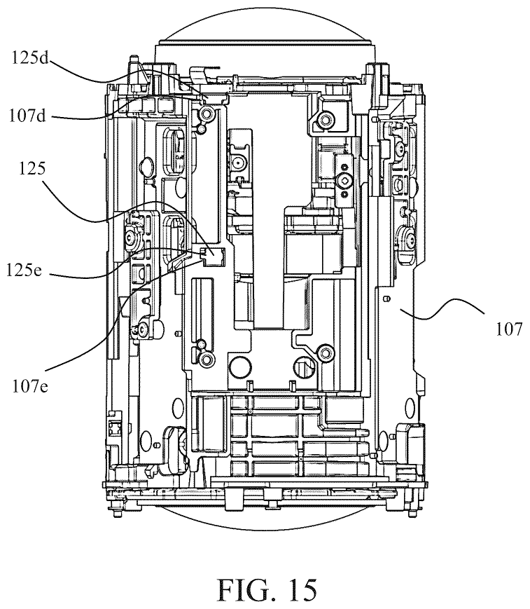

FIG. 15 is a diagram illustrating a state in which the aperture FPC 125 is incorporated into the fixed barrel 107. FIG. 15 omits the focus drive unit 400. As illustrated in FIG. 13, the aperture FPC 125 has the position restricting portions 125d and 125e. The position restricting portions 125d and 125e are inserted into position restricting portions 107d and 107e for the aperture FPC 125 provided in the fixed barrel 107, and positions thereof are restricted relative to the fixed barrel 107. By restricting the aperture FPC 125 in this manner, only the movable unit 125c is allowed to move in accordance with movement of the lens holding frame 112a.

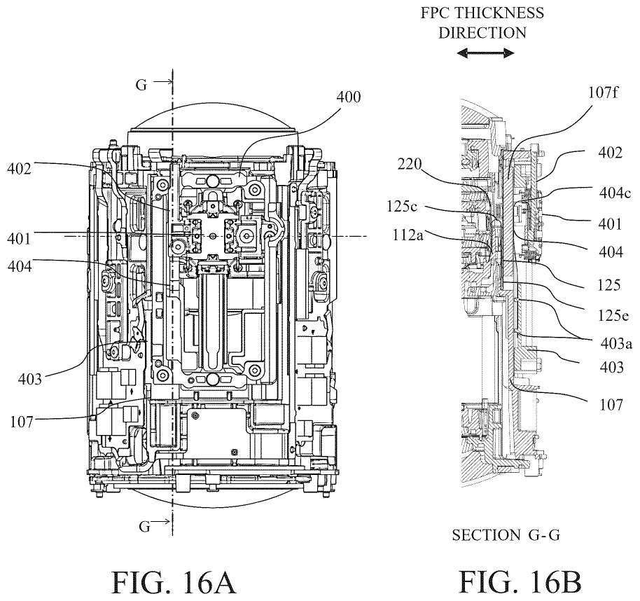

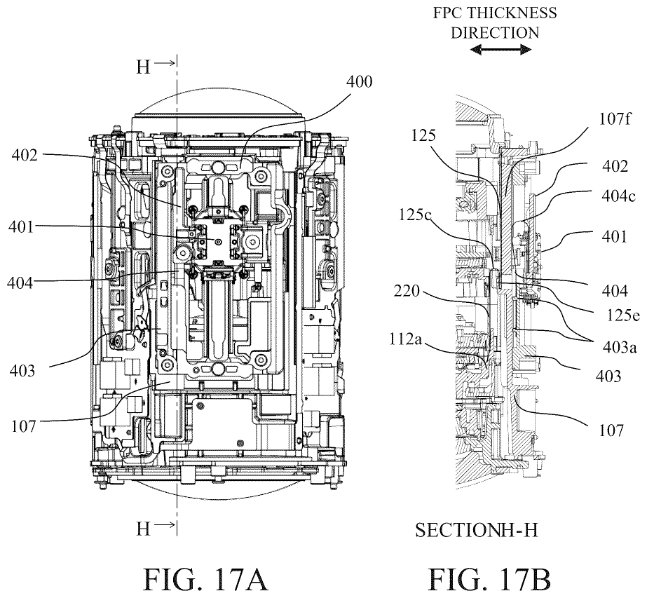

FIG. 16A is a top view of the focus drive unit 400 in the wide-angel (WIDE) state (at the wide-angle end). FIG. 16B is a sectional view for explaining the positional relationship between the aperture FPC 125 and the drive FPC (focus FPC, first board) 404, and corresponds to section G-G in FIG. 16A. FIG. 17A is a top view of the focus drive unit 400 in the telephoto (TELE) state (at the telephoto end). FIG. 17B is a sectional view for explaining the positional relationship between the aperture FPC 125 and the drive FPC 404, and corresponds to section H-H in FIG. 17A.

As illustrated in FIGS. 16B and 17B, one end of the drive FPC 404 is fixed to the vibration-wave-motor movable unit 402, and the other end is positioned and fixed by an engagement unit 403a provided on the motor fixed unit 403. In accordance with the movement of the vibration wave motor movable unit 402, a movable unit 404c of the drive FPC 404 moves while maintaining a U-shape between the vibration wave motor movable unit 402 and a wall 107f of the fixed barrel 107. At this time, the vibration wave motor 401 and the drive FPC 404 are arranged at positions overlapping each other in the radial direction (the lateral direction in FIG. 16A or 17A). Thereby, the size of the focus drive unit 400 in the optical axis direction can be reduced, and the overall length of the lens apparatus 101 can be reduced.

Thus, the aperture FPC 125 and the drive FPC 404 are arranged so as to overlap each other in the board thickness direction. Thereby, the wall 107f of the fixed barrel 107 serves to restrict the movable units of the two boards into a U-shape, thereby reducing the number of components and achieving a space-saving layout.

By providing the wall 107f of the fixed barrel 107, the U-shape is stabilized and contact between the FPCs can be prevented. That is, since actuator drive wirings are routed through the aperture FPC 125 and the drive FPC 404, noise interference between the wirings can be prevented.

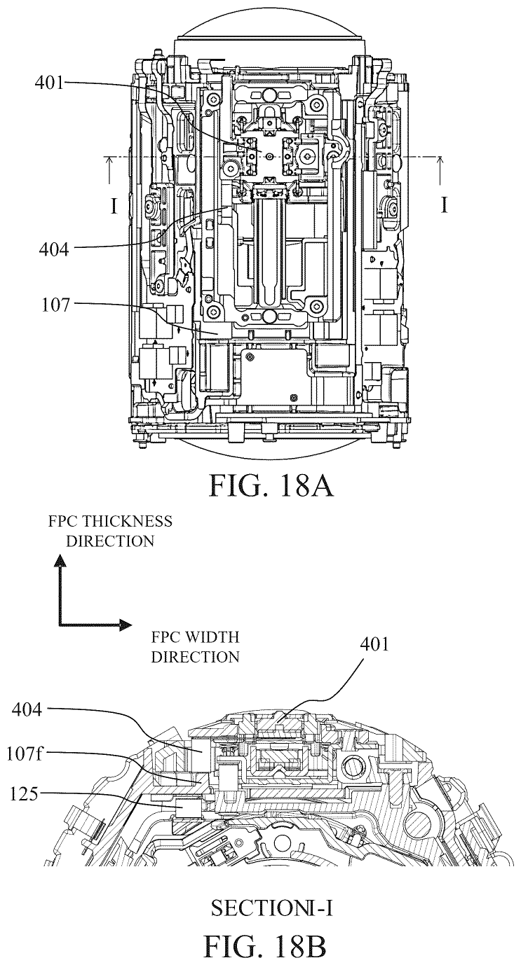

FIG. 18A is a top view of the focus drive unit 400 in the WIDE state. FIG. 18B is an explanatory diagram of an arrangement in which the aperture FPC 125 and the drive FPC 404 are viewed in an optical-axis sectional view, and corresponds to section I-I in FIG. 18A.

As illustrated in FIG. 18B, the aperture FPC 125 and the drive FPC 404 are arranged so as to overlap each other not only in the board thickness direction but also in the board width direction. By arranging them so as to overlap each other in the board width direction in this manner, the holding plate 220 and the wall 107f of the fixed barrel 107 for maintaining the movable unit 404c of the drive FPC 404 in a U-shape can be arranged further toward the inner diameter side, thereby reducing the size of the lens apparatus 101 in the radial direction.

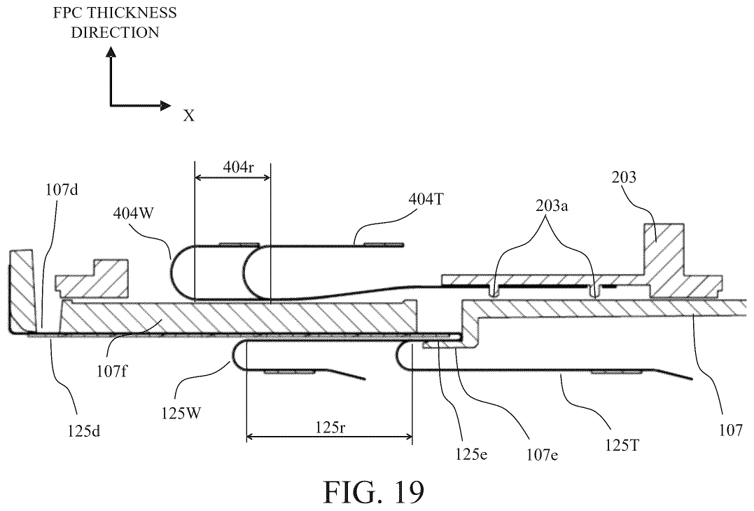

FIG. 19 is an explanatory diagram of movable ranges of the aperture FPC 125 and the drive FPC 404. A WIDE position 125W and a TELE position 125T of the aperture FPC 125 are illustrated. Similarly, a WIDE position 404W and a TELE position 404T of the drive FPC 404 are illustrated.

As illustrated in FIG. 19, a movable range 404r of the drive FPC 404 is disposed between position restricting portions 125d and 125e of the aperture FPC 125. A movable range 125r of the aperture FPC 125 and the movable range 404r of the drive FPC 404 overlap each other in the board thickness direction. Placing the movable ranges so as to overlap each other in the board thickness direction in this manner can achieve a space-saving layout and reduce the overall lens length of the lens apparatus 101.

As illustrated in FIG. 19, the movable range 125r of the aperture FPC 125 and the movable range 404r of the drive FPC 404 overlap each other in the optical axis direction (X-axis direction). The movable ranges overlapping each other in the optical axis direction in this manner can reduce the overall length of the wall 107f of the fixed barrel 107 that restricts each movable unit into a U-shape, and the overall lens length.

As described above, in the present embodiment, an optical apparatus (lens apparatus 101) includes a first board or substrate (drive FPC 404) and a second board or substrate (aperture FPC 125) that is different from the first substrate. Both the first board and the second board are flexible boards that movably bend. A barrel (fixed barrel 107) that holds the first board and the second board includes the wall 107f. The first board is disposed on an outer surface (first surface) of the wall 107f, and the second board is disposed on an inner surface (second surface) of the wall 107f. The present embodiment is not limited to this configuration, and conversely, the inner surface of the wall 107f may be set to the first surface and the outer surface may be set to the second surface.

The first board and the second board may overlap each other in the board thickness direction. The movable range 404r of the first board and the movable range 125r of the second board may overlap each other in the board thickness direction. The second board includes two position restricting portions (position restricting portions 125d and 125e), and the movable range 404r of the first board may be disposed between the two position restricting portions (125d and 125e). The first board may include drive wiring for a linear actuator (vibration wave motor 401), and the second board may include drive wiring for an actuator (aperture drive unit 122) different from the linear actuator (vibration wave motor 401).

The first board and the second board may overlap each other in the board width direction. The linear actuator (vibration wave motor 401) and the first board may overlap each other in the radial direction. The linear actuator (vibration wave motor 401) that drives a lens in the optical axis direction may be disposed outside the barrel (fixed barrel 107). The second board may overlap each other in the radial direction with an adjustment member (adjustment roller 112b) of a lens unit (zoom main unit 112) that holds the second board.

In the present embodiment, the actuator different from the linear actuator is not limited to an aperture-blades drive actuator, and may be an image-stabilization drive actuator.

As described above, in the present embodiment, required circuit components can be disposed by maximizing the side-surface space of the lens apparatus having at least three linear actuators. Thus, the present embodiment can provide a compact optical apparatus while reducing magnetic noise.

In addition, by utilizing space inside and outside the barrel of the lens apparatus, flexible boards can be arranged on the outer surface and the inner surface of the wall of the barrel, respectively. Thus, the present embodiment can reduce the unit length of the zoom main unit, and provide an optical apparatus having a reduced overall lens length.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

For example, instead of the zoom FPC 210, a hard substrate based on a rigid base material such as glass epoxy may be employed. In addition, the applications of the boost inductors 205, 305, and 405 or the inductors 205b, 305b, and 405b are not limited, and they may be part of a circuit that constitutes a power supply for, for example, a voice coil motor as an example of a linear actuator that drives a lens unit.

This embodiment can provide a compact optical apparatus.

This application claims the benefit of Japanese Patent Application No. 2025-051818, filed on Mar. 26, 2025, and Japanese Patent Application No. 2025-239543, filed on Dec. 8, 2025, which are hereby incorporated by reference herein in their entirety.

What is claimed is:

1. An optical apparatus comprising:
three linear actuators, each of which drives a corresponding one of three optical elements;
three drive units, each of which drives a corresponding one of the three linear actuators; and
three position detectors, each of which detects a corresponding one of positions of the three optical elements,
wherein the three linear actuators are arranged in different orientations, and
wherein one of the three drive units and one of the three position detectors are disposed between two of the three linear actuators.

2. The optical apparatus according to claim 1, wherein each of the three drive units includes wiring for drive signals for the three linear actuators.

3. The optical apparatus according to claim 1, wherein each of the three drive units includes a corresponding one of three power supply units for the three linear actuators.

4. The optical apparatus according to claim 3, wherein each of the three power supply units includes a boost inductor.

5. The optical apparatus according to claim 4, wherein the boost inductor is disposed on a surface of substrates farther from an optical axis.

6. The optical apparatus according to claim 3, wherein one of the three power supply units is disposed closer to an object than one of the three position detectors.

7. The optical apparatus according to claim 3, wherein each of the three power supply units and each of the three position detectors are provided on separate substrates.

8. The optical apparatus according to claim 1, wherein one of the three drive units is disposed alongside one of the three position detectors in an optical axis direction.

9. The optical apparatus according to claim 1, wherein the three linear actuators are arranged in a plane perpendicular to an optical axis, at intervals of 120° around the optical axis,
wherein the three drive units are arranged in the plane perpendicular to the optical axis, at intervals of 120° around the optical axis, and
wherein the three position detectors are arranged in the plane perpendicular to the optical axis, at intervals of 120° around the optical axis.

10. The optical apparatus according to claim 1, wherein the three linear actuators, the three drive units, and the three position detectors are arranged in a circumferential direction around an optical axis in a plane perpendicular to the optical axis.

11. The optical apparatus according to claim 1, wherein the three linear actuators, the three drive units, and the three position detectors are arranged so that the three mounting surfaces of the three linear actuators and the three mounting surfaces of the three drive units and the three position detectors form a hexagon.

12. The optical apparatus according to claim 1, wherein each of the three linear actuators includes a vibration wave motor or a voice coil motor.

13. An optical apparatus comprising:
a first substrate;
a second substrate different from the first substrate; and
a barrel that holds the first substrate and the second substrate,
wherein each of the first substrate and the second substrate is a flexible substrate that can move and bend,
wherein the barrel has a wall, and
wherein the first substrate is disposed on a first surface of the wall, and the second substrate is disposed on a second surface of the wall.

14. The optical apparatus according to claim 13, wherein the first surface is an outer surface of the wall, and
wherein the second surface is an inner surface of the wall.

15. The optical apparatus according to claim 13, wherein the first substrate and the second substrate overlap each other in a substrate thickness direction.

16. The optical apparatus according to claim 13, wherein a movable range of the first substrate and a movable range of the second substrate overlap each other in a substrate thickness direction.

17. The optical apparatus according to claim 13, wherein the second substrate has two position restricting portions, and
wherein a movable range of the first substrate is disposed between the two position restriction portions.

18. The optical apparatus according to claim 13, wherein the first substrate has drive wiring for a linear actuator, and
wherein the second substrate has drive wiring for an actuator different from the linear actuator.

19. The optical apparatus according to claim 13, wherein the first substrate and the second substrate overlap each other in a substrate width direction.

20. The optical apparatus according to claim 13, further comprising a linear actuator,
wherein the linear actuator and the first substrate overlap each other in a radial direction.

21. The optical apparatus according to claim 13, wherein a linear actuator that drives a lens in an optical axis direction is disposed outside the barrel.

22. The optical apparatus according to claim 13, further comprising an adjustment member for a lens unit that holds the second substrate,
wherein the second substrate and the adjustment member overlap each other in a radial direction.
